(19) United States
(12) Patent Application Publication
(10) Pub. No.: US 2025/0091964 A1
(43) Pub. Date: Mar. 20, 2025

(54) A COMPOSITION FOR JOINING AND/OR TREATING MATERIALS

(71) Applicant: QinetiQ Limited, Hampshire (GB)

(72) Inventor: Charles John Michael FOOTER, Hampshire (GB)

(21) Appl. No.: 18/727,895

(22) PCT Filed: Jan. 5, 2023
(86) PCT No.: PCT/EP2023/050140

§ 371 Date: Jul. 10, 2024

(30) Foreign Application Priority Data
Jan. 12, 2022 (GB) 2200306.5

(51) Int. Cl. C04B 41/50; C04B 37/00; C04B 41/00; C04B 41/87

(52) U.S. Cl. CPC C04B 41/50; C04B 37/005; C04B 41/0072; C04B 41/87; C04B 2235/5454; C04B 2237/08; C04B 2237/36

(57) ABSTRACT

There is provided a composition for joining and/or treating ceramic materials. The composition can comprise approximately 15 wt % to approximately 90 wt % ceramic nanoparticles, approximately 0.1 wt % to approximately 8 wt % dispersant, and approximately 2 wt % to approximately 84.9 wt % solvent. There is also provided a method of joining a first ceramic part and a second ceramic part at a joining interface to form a joined ceramic component, and a method of treating a ceramic component at a treatment surface to form a treated ceramic component. There is further provided a joined ceramic component.

### CROSS REFERENCE TO RELATED APPLICATION(S)

This application is a national phase filing under 35 C.F.R. § 371 of and claims priority to PCT Patent Application No. PCT/EP2023/050140, filed on Jan. 5, 2023, and claims the priority benefit under 35 U.S.C. § 119 of British Patent Application No. 2200306.5 filed on Jan. 12, 2022, the contents of each of which are hereby incorporated by reference in their entireties.

### TECHNICAL FIELD

The presently disclosed subject matter relates to a composition for joining and/or treating ceramic materials. The presently disclosed subject matter further relates to a method of joining a first ceramic part and a second ceramic part at a joining interface to form a joined ceramic component, a method of treating a ceramic component at a treatment surface to form a treated ceramic component, and a joined ceramic component.

### BACKGROUND

Complex ceramic parts are used in a variety of applications including aerospace, automotive, infrastructure, healthcare and consumer products. However, manufacturing complex ceramic parts is a challenge. Post-processing of sintered ceramic parts for forming complex shapes is a time-consuming and costly process. Recently, 3D printing technologies have been explored for ceramic manufacturing but with limited success in manufacturing strong complex parts.

Ceramic binders-glues which harden ceramic powders as they dry—are typically used to bind ceramic particles into a desired shape in a mould. However, ceramic binders are typically not suitable for manufacturing high strength complex ceramic parts and can be very expensive. A further issue is that mismatch of the coefficient of thermal expansion (CTE) between substrates being bonded can cause thermo-mechanical stress at the joints of the material, leading to deformation and weaker bonds.

The presently disclosed subject matter has been devised to mitigate or overcome at least some of the above-mentioned problems.

### SUMMARY

In accordance with a first aspect of the presently disclosed subject matter, there is provided a composition for joining and/or treating ceramic materials, the composition comprising: approximately 15 wt % to approximately 90 wt % ceramic nanoparticles; approximately 0.1 wt % to approximately 8 wt % dispersant; and approximately 2 wt % to approximately 84.9 wt % solvent.

The presently disclosed subject matter thereby provides a composition which enables ceramic materials to be joined and/or treated in a more effective manner to form complex shapes. Complex components such as rotors, propellors and/or fans may be formed. Advantageously, this allows simple and efficient manufacture of complex and extremely strong components from smaller and simpler parts without any need for a ceramic binder. The parts from which the complex components are made may be inexpensive, single die pressed parts. The use of a dispersant, or dispersing agent, in the composition enables high quality structures to be built by forcing the ceramic nanoparticles into any surface roughness or pores in the starting materials.

The composition may comprise approximately 0.5 wt % to 1 wt % dispersant.

The composition may comprise approximately 0.7 wt % dispersant.

The dispersant may comprise a non-ionic surfactant.

The solvent may be isopropyl alcohol.

The ceramic material may comprise SiAlON, zinc sulphide (ZnS) or spinel.

The composition may comprise approximately 60 wt % to approximately 80 wt % ceramic nanoparticles.

The composition may comprise approximately 70 wt % ceramic nanoparticles.

The ceramic material may comprise SiAlON and the ceramic nanoparticles may have a diameter of approximately 3 nm to approximately 50 nm.

The ceramic material may comprise SiAlON and the ceramic nanoparticles may have a diameter of approximately 3 nm to approximately 11 nm.

The ceramic material may comprise SiAlON and the ceramic nanoparticles may have a diameter of approximately 8 nm to approximately 16 nm.

The ceramic material may comprise SiAlON and the ceramic nanoparticles may have a diameter of approximately 13 nm to approximately 21 nm.

The ceramic material may comprise SiAlON and the ceramic nanoparticles may have a diameter of approximately 18 nm to approximately 26 nm.

The ceramic material may comprise ZnS and the ceramic nanoparticles may have a diameter of approximately 15 nm to approximately 50 nm.

The ceramic material may comprise ZnS and the ceramic nanoparticles may have a diameter of approximately 17 nm.

The ceramic material may comprise spinel and the ceramic nanoparticles may have a diameter of approximately 15 nm to approximately 50 nm.

The ceramic material may comprise spinel and the ceramic nanoparticles may have a diameter of approximately 18 nm.

In accordance with a second aspect of the presently disclosed subject matter, there is provided a method of joining a first ceramic part and a second ceramic part at a joining interface to form a joined ceramic component, the method comprising: applying a composition according to the first aspect to the first ceramic part at the joining interface; arranging the second ceramic part in contact with the composition at the joining interface; heating the first ceramic part, the second ceramic part and the composition to a joining temperature for a joining time period.

The presently disclosed subject matter thereby enables ceramics to be joined in a more effective manner to form complex shapes. Complex components such as rotors, propellors and/or fans may be formed. Advantageously, this allows simple and efficient manufacture of complex and extremely strong components from smaller and simpler parts without any need for a ceramic binder. The parts from which the complex components are made may be inexpensive, single die pressed parts. The simple and efficient manufacturing process enabled by the presently disclosed subject matter removes any need for more complicated manufacturing techniques, such as 3D printing. The use of a dispersant, or dispersing agent, in the composition enables high quality structures to be built by forcing the ceramic nanoparticles into any surface roughness or pores in the starting materials. The presently disclosed subject matter allows ceramic components to be joined even at fully dense parts of each component.

In addition, the presently disclosed subject matter enables ceramic parts to be joined whilst maintaining the optics of the original ceramic material. For example, two optically transparent ceramic parts may be joined such that the optical transparency is maintained even in the joined component.

The composition may comprise the same material as the first ceramic part and the second ceramic part. Advantageously, the material used for joining the ceramic parts may be the same as the material of the ceramic parts themselves, which means that the method does not result in any stress or CTE mismatch between the ceramic parts being joined.

The composition may be applied at approximately 0.5 ml per cm² of the joining interface.

The first ceramic joining portion and the second ceramic joining portion may comprise SiAlON, ZnS or spinel.

The joining temperature may be approximately 800° C. to approximately 1400° C.

The first ceramic joining portion and the second ceramic joining portion may comprise SiAlON and the joining temperature may be approximately 1000° C. to approximately 1300° C.

The first ceramic joining portion and the second ceramic joining portion may comprise SiAlON and the joining temperature may be approximately 1100° C. to approximately 1300° C.

The first ceramic joining portion and the second ceramic joining portion may comprise SiAlON and the joining temperature may be approximately 1200° C.

The first ceramic joining portion and the second ceramic joining portion may comprise SiAlON and the joining temperature may be approximately 1300° C.

The first ceramic joining portion and the second ceramic joining portion may comprise SiAlON and the joining time period may be approximately 120 minutes to approximately 420 minutes.

The first ceramic joining portion and the second ceramic joining portion may comprise SiAlON and the joining time period may be approximately 240 minutes to approximately 420 minutes.

The first ceramic joining portion and the second ceramic joining portion may comprise SiAlON and the joining time period may be approximately 300 minutes to approximately 420 minutes.

The first ceramic joining portion and the second ceramic joining portion may comprise SiAlON and the joining time period may be approximately 360 minutes.

The first ceramic joining portion and the second ceramic joining portion may comprise SiAlON and the joining time period may be approximately 420 minutes.

The first ceramic joining portion and the second ceramic joining portion may comprise ZnS and the joining temperature may be approximately 800° C. to approximately 1185° C.

The first ceramic joining portion and the second ceramic joining portion may comprise ZnS and the joining temperature may be approximately 1000° C. to approximately 1185° C.

The first ceramic joining portion and the second ceramic joining portion may comprise ZnS and the joining temperature may be approximately 1100° C. to approximately 1185° C.

The first ceramic joining portion and the second ceramic joining portion may comprise ZnS and the joining temperature may be approximately 1100° C.

The first ceramic joining portion and the second ceramic joining portion may comprise ZnS and the joining temperature may be approximately 1150° C.

The first ceramic joining portion and the second ceramic joining portion may comprise ZnS and the joining temperature may be approximately 1175° C.

The first ceramic joining portion and the second ceramic joining portion may comprise ZnS and the joining temperature may be approximately 1185° C.

The first ceramic joining portion and the second ceramic joining portion may comprise ZnS and the joining time period may be approximately 60 minutes to approximately 240 minutes.

The first ceramic joining portion and the second ceramic joining portion may comprise ZnS and the joining time period may be approximately 100 minutes to approximately 300 minutes.

The first ceramic joining portion and the second ceramic joining portion may comprise ZnS and the joining time period may be approximately 120 minutes.

The first ceramic joining portion and the second ceramic joining portion may comprise ZnS and the joining time period may be approximately 240 minutes.

The first ceramic joining portion and the second ceramic joining portion may comprise spinel and the joining temperature may be approximately 900° C. to approximately 1125° C.

The first ceramic joining portion and the second ceramic joining portion may comprise spinel and the joining temperature may be approximately 1000° C. to approximately 1125° C.

The first ceramic joining portion and the second ceramic joining portion may comprise spinel and the joining temperature may be approximately 1125° C.

The first ceramic joining portion and the second ceramic joining portion may comprise spinel and the joining time period may be approximately 60 minutes to approximately 480 minutes.

The first ceramic joining portion and the second ceramic joining portion may comprise spinel and the joining time period may be approximately 100 minutes to approximately 200 minutes.

The first ceramic joining portion and the second ceramic joining portion may comprise spinel and the joining time period may be approximately 120 minutes.

The first ceramic joining portion and the second ceramic joining portion may comprise spinel and the joining time period may be approximately 180 minutes.

In accordance with a third aspect of the presently disclosed subject matter, there is provided a method of treating a ceramic component at a treatment surface to form a treated ceramic component, the method comprising: applying a composition according to the first aspect to the ceramic component at the treatment surface; heating the ceramic component and the composition to a treatment temperature for a treatment time period; wherein at the treatment surface pores of the ceramic component contain infiltrated ceramic nanoparticles such that the treatment surface is densified.

In situations in which the components are not fully dense, the composition can be used to treat and densify ceramic components. In other words, a ceramic component can be treated at a treatment surface such that after treatment pores of the ceramic component at the treatment surface contain infiltrated ceramic nanoparticles which leads to greater density and hardness.

The treatment temperature and the treatment time period may be any value as outlined above in respect of the joining temperature and the joining time period of the second aspect.

The composition may comprise the same material as the ceramic component. Alternatively, the composition may comprise a different material to the ceramic component.

In accordance with a fourth aspect of the presently disclosed subject matter, there is provided a joined ceramic component comprising: a first ceramic part joined to a second ceramic part; a joining region between the first ceramic part and the second ceramic part; wherein at the joining region surface pores of the first ceramic part and the second ceramic part contain infiltrated ceramic nanoparticles.

The presently disclosed subject matter can be used to join and/or treat any ceramic material. For example, the presently disclosed subject matter may be used to join and/or treat SiAlON, spinel, and/or ZnS.

The presently disclosed subject matter may be used to join and/or treat sintered or partially sintered SiAlON ceramics.

The presently disclosed subject matter may be used for manufacturing lightweight engine parts.

The presently disclosed subject matter may be used for manufacturing complex high temperature ceramics.

The presently disclosed subject matter may be used for manufacturing rocket nozzle fans and/or aerospace surfaces.

The presently disclosed subject matter also extends to use of any of the compositions described above for joining two ceramic parts.

The presently disclosed subject matter further extends to use of any of the compositions described above for treating a ceramic part.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the presently disclosed subject matter will now be described, by way of example only, with reference to the accompanying drawings, in which:

FIG. 1 is a flowchart showing a method of joining a first ceramic part and a second ceramic part at a joining interface to form a joined ceramic component, in accordance with embodiments of the presently disclosed subject matter;

FIG. 2 is a schematic diagram showing the joining of a first ceramic part and a second ceramic part to form a joined ceramic component, in accordance with embodiments of the presently disclosed subject matter;

FIG. 3 is a flowchart showing a method of treating a ceramic component at a treatment surface to form a treated ceramic component, in accordance with embodiments of the presently disclosed subject matter;

FIG. 4 is a schematic diagram showing the treatment of a ceramic component at a treatment surface to form a treated ceramic component, in accordance with embodiments of the presently disclosed subject matter;

FIG. 5 is a schematic diagram showing a process of joining two partially-sintered ceramic parts to form a uniform ceramic component, in accordance with embodiments of the presently disclosed subject matter;

FIG. 6 is a schematic diagram showing a process of joining several simple ceramic parts to form complex and functional ceramic structures, in accordance with embodiments of the presently disclosed subject matter;

FIG. 7 is an image showing a joined SiAlON sample in which the joined component has been cut open at the join, in accordance with embodiments of the presently disclosed subject matter;

FIG. 8 is an image and corresponding schematic diagram showing a joined ZnS sample, in accordance with embodiments of the presently disclosed subject matter;

FIG. 9 is a schematic diagram showing the manufacturing of a ZnS dome structure, in accordance with embodiments of the presently disclosed subject matter;

FIG. 10 is an image and corresponding schematic diagram showing a joined spinel sample, in accordance with embodiments of the presently disclosed subject matter;

FIG. 11a is a schematic diagram showing a split sample configuration for three-point bend testing, in accordance with embodiments of the presently disclosed subject matter; and

FIG. 11b is an image showing three-point bend testing of a joined, optically transparent spinel sample, in accordance with embodiments of the presently disclosed subject matter.

### DETAILED DESCRIPTION

The presently disclosed subject matter relates to a composition for joining and/or treating ceramic materials. The presently disclosed subject matter further relates to a method of joining a first ceramic part and a second ceramic part at a joining interface to form a joined ceramic component. The presently disclosed subject matter also relates to a method of treating a ceramic component at a treatment surface to form a treated ceramic component. The presently disclosed subject matter further relates to a joined ceramic component.

The composition comprises approximately 15 wt % to approximately 90 wt % ceramic nanoparticles, approximately 0.1 wt % to approximately 8 wt % dispersant, and approximately 2 wt % to approximately 84.9 wt % solvent. The inventors have determined that such a composition enables ceramic materials to be joined and/or treated in a more effective manner to form complex shapes and components. In particular, the combined use of ceramic nanoparticles and a dispersant in the composition advantageously enables the ceramic nanoparticles to be forced into any surface roughness or pores in the starting ceramic parts or materials, which in turn enables strong, high-quality complex structures to be formed.

The composition may be referred to herein as a slurry or a nanoslurry.

The ceramic parts may comprise any suitable ceramic material, such as for example SiAlON, ZnS or spinel, though other suitable ceramic materials may be used.

The ceramic nanoparticles may be any suitable ceramic material, such as for example SiAlON, ZnS or spinel, though other suitable ceramic materials may be used. The size of the ceramic nanoparticles may vary based on the ceramic material. For example, SiAlON nanoparticles may have a diameter of approximately 3 nm to approximately 50 nm. ZnS nanoparticles may have a diameter of approximately 15 nm to approximately 50 nm. Spinel nanoparticles may have a diameter of approximately 15 nm to approximately 50 nm.

The dispersant may be any suitable dispersant or dispersing agent. For example the dispersant may comprise a non-ionic surfactant such as Triton X-100® (octyl phenol ethoxylate), though any non-ionic surfactant may be used.

The solvent may be any suitable solvent, such as for example isopropyl alcohol (IPA).

The composition parameters may be any suitable parameters. For example, the amount of dispersant may be varied to approximately 0.5 wt % to 1 wt %. As a further example, the amount of ceramic nanoparticles may be varied to approximately 60 wt % to approximately 80 wt %.

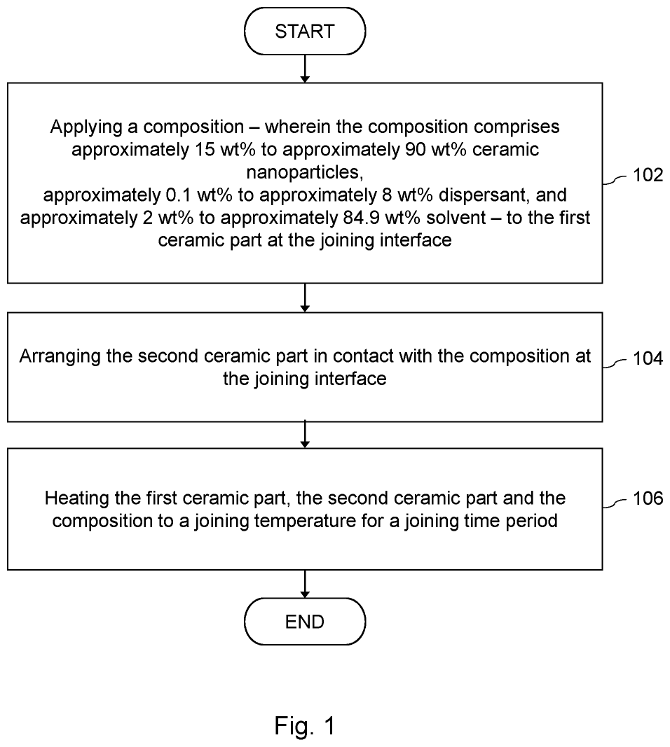

General and specific embodiments of the presently disclosed subject matter will be described below with reference to FIGS. 1 to 11b.

The inventors have determined that the composition can be used to join and/or treat ceramic materials. A method of joining a first ceramic part and a second ceramic part at a joining interface to form a joined ceramic component is depicted in FIG. 1. The method begins by applying, at Step 102, a composition, according to the presently disclosed subject matter as outlined above, to the first ceramic part at the joining interface. The method continues by arranging, at Step 104, the second ceramic part in contact with the composition at the joining interface. Lastly the method involves heating, at Step 106, the first ceramic part, the second ceramic part and the composition to a joining temperature for a joining time period.

This method allows simple and efficient manufacture of complex and extremely strong components from smaller and simpler parts without any need for a ceramic binder. The parts from which the complex components are made may be any suitable parts, such as inexpensive single die pressed parts.

The joining method may be referred to herein as slurry phase joining.

The joining temperature may be, for example, approximately 800° C. to approximately 1400° C., though the joining temperature may be any suitable temperature. The joining temperature may in addition vary based on the material of the ceramic nanoparticles.

The joining time period may be, for example, approximately 60 minutes to approximately 480 minutes, though the joining time period may be any suitable time period. The joining time period may in addition vary based on the material of the ceramic nanoparticles.

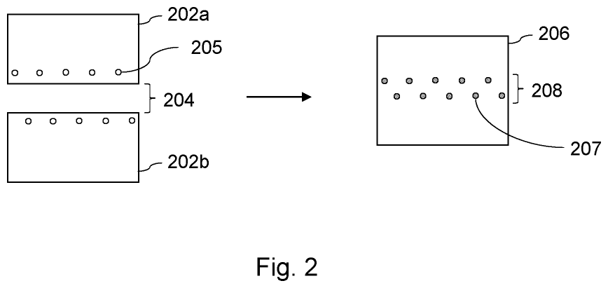

FIG. 2 shows the joining of a first ceramic part 202a and a second ceramic part 202b to form a joined ceramic component 206. The composition (not shown) is applied to the first ceramic part 202a at the joining interface 204. The second ceramic part 202b is then arranged in contact with the composition at the joining interface 204. Heating the first ceramic part 202a, the second ceramic part 202b and the composition to a joining temperature for a joining time period then results in the formation of a joined ceramic component 206. The joined ceramic component 206 therefore comprises the first ceramic part 202a joined to the second ceramic part 202b, and a joining region 208 between the first ceramic part 202a and the second ceramic part 202b. As shown in FIG. 2, the first ceramic part 202a joined to the second ceramic part 202b comprise surface pores 205 which are typically empty before joining. After joining, surface pores 207 of the first ceramic part 202a and the second ceramic part 202b at the joining region 208 contain infiltrated ceramic nanoparticles from the composition.

The composition comprises the same ceramic material as the first ceramic part 202a and the second ceramic part 202b, which results in an even stronger join between the first ceramic part 202a and the second ceramic part 202b because stress or CTE mismatch between the ceramic parts being joined is avoided.

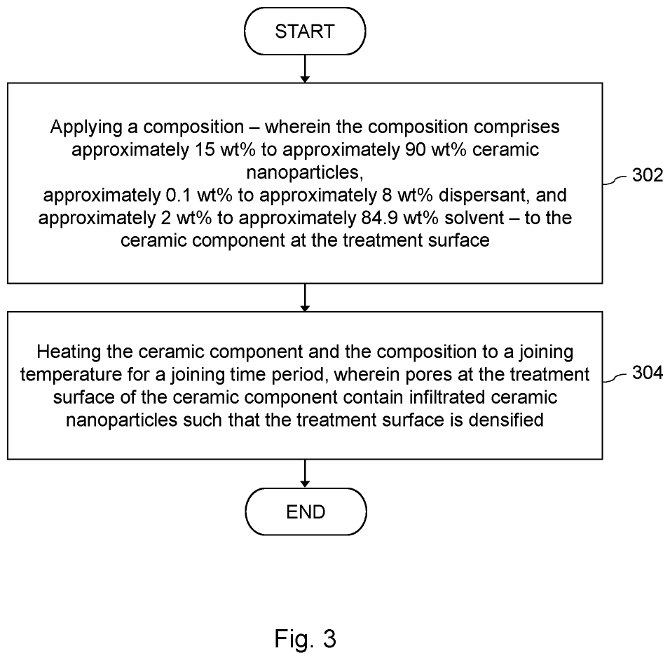

A method of treating a ceramic component at a treatment surface to form a treated ceramic component is depicted in FIG. 3. The method begins by applying, at Step 302, the composition to the ceramic component at the treatment surface. The method then involves heating, at Step 304, the ceramic component and the composition to a joining temperature for a joining time period. Pores at the treatment surface of the ceramic component contain infiltrated ceramic nanoparticles such that the treatment surface is densified.

The ceramic component may comprise any suitable ceramic material, such as for example SiAlON, ZnS or spinel, though other suitable ceramic materials may be used.

The treatment temperature may be, for example, approximately 800° C. to approximately 1400° C., though the treatment temperature may be any suitable temperature. The treatment temperature may in addition vary based on the material of the ceramic nanoparticles.

The treatment time period may be, for example, approximately 60 minutes to approximately 480 minutes, though the treatment time period may be any suitable time period. The treatment time period may in addition vary based on the material of the ceramic nanoparticles.

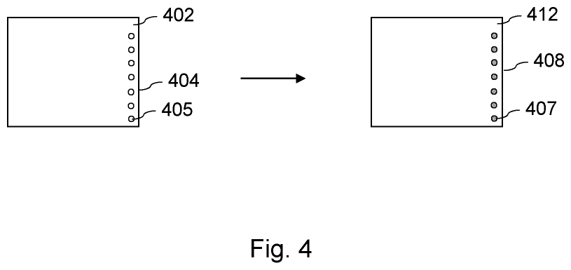

The composition may comprise the same material as the ceramic component. Alternatively, the composition may comprise a different material to the ceramic component.

Where the composition comprises the same material as the ceramic component, the primary effect of the treatment is to densify the ceramic components at their surface. FIG. 4 shows the treatment of a ceramic component 402 at a treatment surface 404 to form a treated ceramic component 412. The composition (not shown) is applied to the ceramic component 402 at a treatment surface 404. The ceramic component 402 and the composition are then heated to a treatment temperature for a treatment time period. As shown in FIG. 4, the ceramic component 402 comprises surface pores 405 which are typically empty before treatment. After treatment, surface pores 407 at the treatment surface of the treated ceramic component 412 contain infiltrated ceramic nanoparticles from the composition. In this way, the treatment surface becomes densified. This method can be used to increase the density and hardness of the ceramic component.

Where the composition comprises a different material to the ceramic component, the treatment will cause nanoparticles of a different ceramic material to infiltrate into pores of the ceramic component at the surface. This will have a densifying effect. It may also alter properties of the ceramic at the surface: for example a different heat expansion coefficient, increasing hardness, or providing a different appearance. This treatment process can allow the surface of a ceramic component to have different properties to the bulk of a ceramic component. This can be particularly advantageous if, for example, the ceramic material of the nanoparticles has beneficial properties, but is expensive. The bulk of the ceramic can be made from a relatively inexpensive material to reduce the overall cost of the component, and the nanoparticles can be made of the more expensive material to provide the desirable properties.

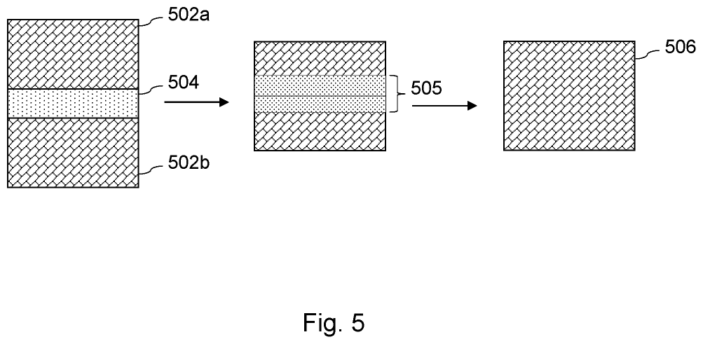

Turning to FIG. 5, a process of joining two partially-sintered ceramic parts 502a, 502b to form a uniform ceramic component 506 is shown. The ceramic parts 502a, 502b are approximately 90% sintered. A composition 504 or nano slurry, according to the presently disclosed subject matter as outlined above, is applied to the first ceramic part 502a at a joining interface residing between the first ceramic part 502a and the second ceramic part 502b. The second ceramic part 502b is then arranged in contact with the composition 504 at the joining interface. The first ceramic part 502a, the second ceramic part 502b and the composition 504 are heated to a joining temperature for a joining time period. During this process, the composition begins to infiltrate into the pores of the ceramic parts 502a, 502b, resulting in partial infiltration 505 of the composition with the parts 502a, 502b. As this process continues, the composition acts to force the ceramic nanoparticles into any surface roughness or pores in the ceramic parts 502a, 502b and thereby join the ceramic parts 502a, 502b to form a uniform ceramic body 506.

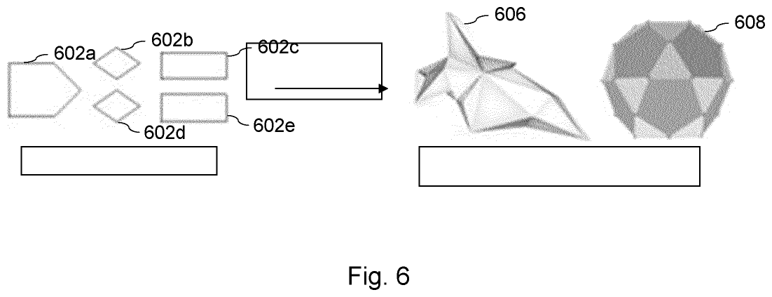

FIG. 6 shows a process of joining several starting ceramic parts 602a, 602b, 602b, 602c, 602d, 602e to form complex and functional ceramic structures 606, 608. The starting parts are relatively simple and easy to make. The parts are joined via joining method of the presently disclosed subject matter, as outlined above. The resulting structures are complex in shape and can serve various functions.

The presently disclosed subject matter will now be illustrated further with reference to the following examples.

### Example 1

Samples of SiAlON were fused and joined according to the present example.

Adjoining parts of SiAlON were fused and joined using a novel diffusion melt flow method to form a joined SiAlON component. A nano-particulate SiAlON composition was used to join the adjoining parts.

To form the composition, approximately 70 wt % SiAlON nanoparticles having a diameter of between approximately 13 nm and approximately 21 nm were mixed with 0.7 wt % Triton X-100® (octyl phenol ethoxylate) dispersant and approximately 29.3 wt % isopropyl alcohol (IPA) solvent to form a slurry. The SiAlON nanoparticles included a unique mixture of nanoparticle sizes as they included a Si/Al oxide nitride mix.

The slurry was lapped onto one of the SiAlON parts at the joining interface at approximately 0.5 ml per cm² of the joining interface. No preparation or scoring was required at the joining interface. The consistency of the slurry once lapped was similar to that of battery electrode ink.

The second SiAlON part was arranged in contact with the composition at the joining interface. The first SiAlON part, the second SiAlON part and the composition were heated to a joining temperature between approximately 1000° C. and approximately 1300° C. for a joining time period. The joining temperature was lower than the bulk sintering temperature for SiAlON (1400° C.).

Experimental conditions for the joining are outlined in further detail in Table 1 below.

TABLE 1
Experimental conditions for joining samples of SiAlON.

| Time (minutes) | Temperature (° C.) | Comment |
|---|---|---|
| 120 | 1000 | Weak join |
| 120 | 1100 | Weak join |
| 120 | 1200 | Weak join |
| 180 | 1000 | Weak join |
| 180 | 1100 | Weak join |
| 180 | 1200 | Weak join |
| 240 | 1000 | Weak join |
| 240 | 1100 | Weak join |
| 240 | 1200 | Weak join |
| 360 | 1000 | Weak join |
| 360 | 1100 | Weak join |
| 360 | 1200 | Strong join |
| 420 | 1300 | Strong join |

Joined SiAlON components exhibited strong joins at the optimised temperatures of 1200° C. (for 360 minutes) and 1300° C. (for 420 minutes).

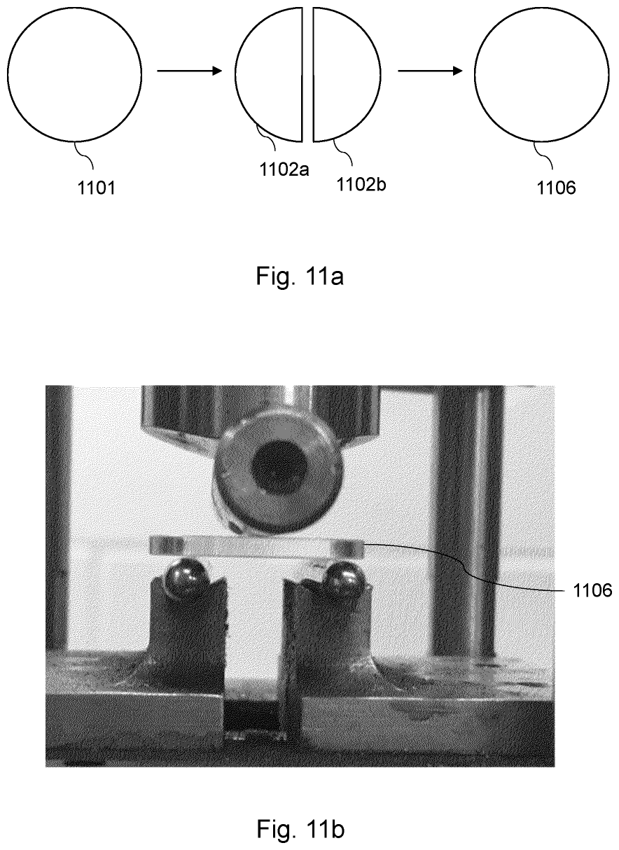

Three-point bend tests were performed to test the mechanical strength of the joined SiAlON component. The three-point bend tests were performed using the split sample configuration shown in FIG. 11a. A disc of SiAlON material was first split in half and then joined using the above method. The joined SiAlON component was tested under the three-point bend test for mechanical strength. The three-point bend tests showed approximately 90% of bulk SiAlON flexural stress to be achieved for 36 mm join lengths for 5 mm thick samples. The maximum load and maximum flexural strength for SiAlON blank and joined materials are shown in Table 2 below. The joined components were measured to be 95.6% and 97.3% dense upon joining.

TABLE 2
Maximum load and maximum flexural strength
for SiAlON blank and joined materials.

| | | | Maximum |
|---|---|---|---|
| | Sample | Maximum Load | Flexural Strength |
| Material | Dimensions | (kN) | (MPa) |
| SiAlON blank | 36 mm diameter; | 1.968 | 171.4 |
| | 5 mm thickness. | | |
| SiAlON join | 36 mm diameter; | 1.767 | 160.4 |
| | 5 mm thickness. | | |

The present method therefore enabled the manufacture of high quality samples of fused and joined SiAlON with good mechanical properties. In addition, very good IR transmission was maintained in the samples post-joining. Advantageously, the present method enables the manufacture of such joined SiAlON whereas known methods of joining/fusing, such as diffusion melt flow, microwave heating, and ultrasonic joining, produce unsuccessful results.

Alternative shapes and structures can also be made. For example, the composition and joining method of the presently disclosed subject matter was used to create a SiAlON dome structure. Alternate SiAlON compositions with varying amounts of SiAlON nanoparticles may be used to create layered structures, such as for example a layered dome structure.

### Example 2

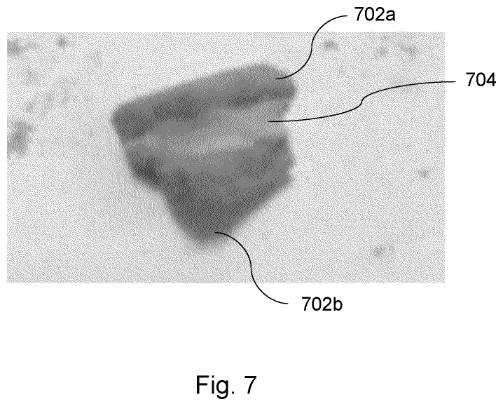

A 20% porous sample of SiAlON was used to demonstrate infiltration of the slurry into the samples to be joined. A joined SiAlON sample is shown in FIG. 7, in which the joined component has been cut open at the join into two parts 702a, 702b. The image shows that the slurry has been infiltrated into the SiAlON joining parts at the joining interface 704 as part of the joining process. The joining interface of the sample has a lighter shade as it is a different stoichiometry of SiAlON, purposely used in order to view the difference in comparison to the SiAlON material of the joining parts.

### Example 3

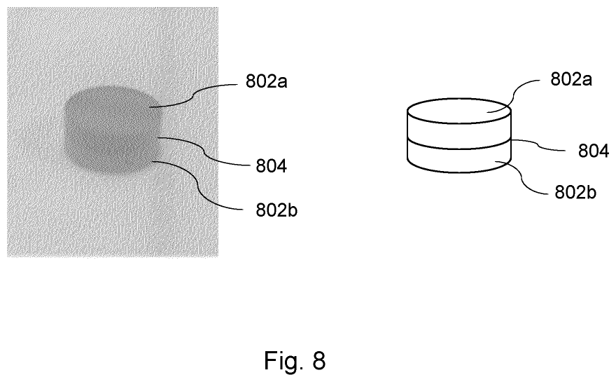

Samples of zinc sulphide (ZnS) were fused and joined according to the present example. An image and corresponding schematic diagram of the joined ZnS sample is shown in FIG. 8.

Adjoining parts 802a, 802b of ZnS were fused and joined using a novel diffusion melt flow method to form a joined ZnS component. A nano-particulate ZnS composition was used to join the adjoining parts, at joining temperatures of approximately 800° C. to approximately 1185° C., for time periods between approximately 1 hour and approximately 4 hours.

To form the composition, approximately 70 wt % ZnS nanoparticles having a diameter of approximately 17 nm were mixed with approximately 0.7 wt % Triton X-100® (octyl phenol ethoxylate) dispersant and approximately 29.3 wt % isopropyl alcohol (IPA) solvent to form a slurry. The slurry was lapped onto one of the ZnS parts 802a at the joining interface 804 at approximately 0.5 ml per cm² of the joining interface 804. No preparation or scoring was required at the joining interface 804.

The second ZnS part 802b was arranged in contact with the composition at the joining interface 804. The first ZnS part 802a, the second ZnS part 802b and the composition were heated to a joining temperature between approximately 800° C. and approximately 1185° C. for a joining time period.

Experimental conditions for the joining are outlined in further detail in Table 3 below.

TABLE 3
Experimental conditions for joining samples of ZnS.

| Time (minutes) | Temperature (° C.) | Comment |
|---|---|---|
| 60 | 800 | Weak join |
| 120 | 800 | Weak join |
| 240 | 800 | Weak join |
| 60 | 1000 | Weak join |
| 120 | 1000 | Weak join |
| 240 | 1000 | Weak join |
| 60 | 1200 | Clouded join |
| 120 | 1200 | Weak join |
| 120 | 1100 | Weak join |
| 240 | 1100 | Join - no clouding |
| 120 | 1150 | Join - no clouding |
| 120 | 1175 | Join - no clouding |
| 120 | 1185 | Join - no clouding |

Joined ZnS components exhibited no clouding at the optimised temperatures of 1100° C. (for 240 minutes), 1150° C. (for 120 minutes), 1175° C. (for 120 minutes), and 1185° C. (for 120 minutes).

Three-point bend tests were performed to test the mechanical strength of the joined ZnS component. The three-point bend tests were performed using the split sample configuration shown in FIG. 11a. A disc of ZnS material was first split in half and then joined using the above method. The joined ZnS component was tested under the three-point bend test for mechanical strength. The three-point bend tests showed approximately 66% of bulk ZnS flexural stress to be achieved for 25 mm join lengths for 3 mm thick samples. The maximum load and maximum flexural strength for ZnS blank and joined materials are shown in Table 4 below.

TABLE 4
Maximum load and maximum flexural strength
for ZnS blank and joined materials.

| | | | Maximum |
|---|---|---|---|
| | Sample | Maximum Load | Flexural Strength |
| Material | Dimensions | (kN) | (MPa) |
| ZnS blank | 25 mm diameter; | 0.327 | 81.7 |
| | 3 mm thickness. | | |
| ZnS join | 25 mm diameter; | 0.217 | 54.1 |
| | 3 mm thickness. | | |

The present method therefore enabled the manufacture of high quality samples of fused and joined ZnS with good mechanical properties. In addition, very good IR transmission was maintained in the samples post-joining. Advantageously, the present method enables the manufacture of such joined ZnS whereas known methods of joining/fusing, such as diffusion melt flow, microwave heating, and ultrasonic joining, produce unsuccessful results.

### Example 4

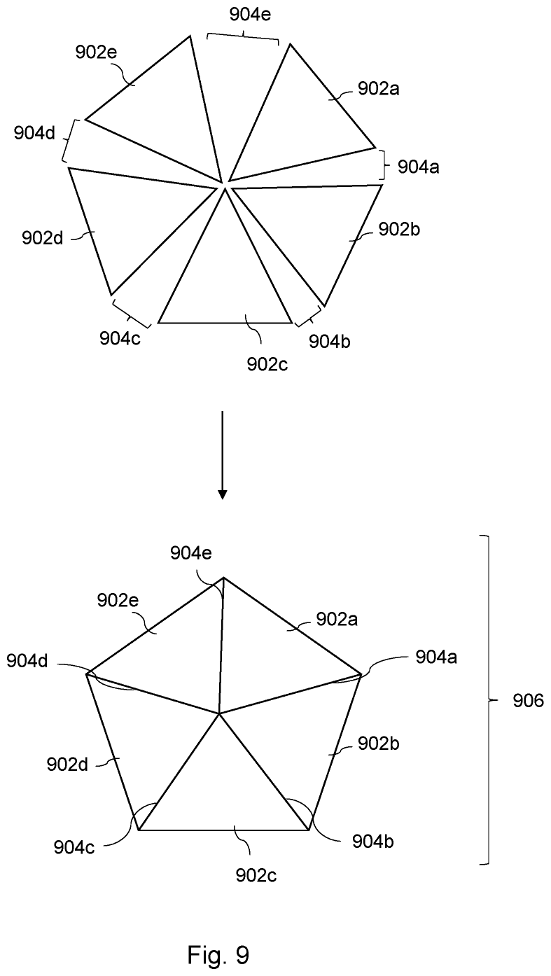

Various structures can be formed using the joining process. As a further example, the composition and joining method of the presently disclosed subject matter was used to manufacture a ZnS dome structure, as shown in FIG. 9. A series of triangular ZnS parts 902a-e were joined at joining interfaces 904a-e to form a faceted triangular dome 906. The composition parameters and the experimental conditions were the same as provided above for Example 3.

### Example 5

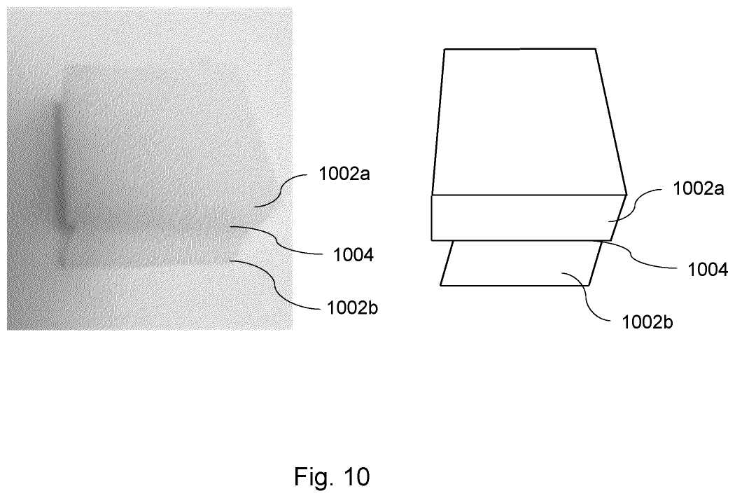

Samples of spinel were fused and joined according to the present example. An image and corresponding schematic diagram of the joined spinel sample is shown in FIG. 10.

Adjoining parts 1002a, 1002b of spinel were fused and joined using a novel diffusion melt flow method to form a joined spinel component. A nano-particulate spinel composition was used to join the adjoining parts, at joining temperatures of approximately 800° C. to approximately 1185° C., for time periods between approximately 1 hour and approximately 4 hours.

To form the composition, approximately 70 wt % spinel nanoparticles having a diameter of approximately 18 nm were mixed with approximately 0.7 wt % Triton X-100® (octyl phenol ethoxylate) dispersant and approximately 29.3 wt % isopropyl alcohol (IPA) solvent to form a slurry. The slurry was lapped onto one of the spinel parts 1002a at the joining interface 1004 at approximately 0.5 ml per cm² of the joining interface 1004. No preparation or scoring was required at the joining interface 1004.

The second spinel part 1002b was arranged in contact with the composition at the joining interface 1004. The first spinel part 1002a, the second spinel part 1002b and the composition were heated to a joining temperature between approximately 900° C. and approximately 1125° C. for a joining time period.

Experimental conditions for the joining are outlined in further detail in Table 5 below.

TABLE 5
Experimental conditions for joining samples of spinel.

| Time (minutes) | Temperature (° C.) | Comment |
|---|---|---|
| 480 | 900 | Weak join |
| 360 | 900 | Weak join |
| 240 | 900 | Weak join |
| 180 | 900 | Weak join |
| 120 | 900 | Weak join |
| 60 | 900 | Weak join |
| 240 | 1000 | Clouded join |
| 180 | 1100 | Clouded join |
| 120 | 1100 | Clouded join |
| 60 | 1100 | Clouded join |
| 180 | 1125 | Strong join |
| 120 | 1125 | Strong join |
| 60 | 1125 | Clouded join |

Joined spinel components exhibited a strong join with no clouding at the optimised temperature of 1125° C. (for 120 minutes or 180 minutes).

Three-point bend tests were performed to test the mechanical strength of the joined spinel component. The three-point bend tests were performed using the split sample configuration shown in FIG. 11a. A disc 1101 of spinel material was first split in half to form two half components 1102a, 1102b, and then joined using the above method. The joined spinel component 1106 was tested under the three-point bend test for mechanical strength. Three-point bend testing of a joined, optically transparent spinel sample 1106 is shown in FIG. 11b. The maximum load and maximum flexural strength for spinel blank and joined materials are shown in Table 6 below.

TABLE 6
Maximum load and maximum flexural strength
for spinel blank and joined materials.

| | | | |
|---|---|---|---|
| | | | Maximum |
| | Sample | Maximum Load | Flexural Strength |
| Material | Dimensions | (kN) | (MPa) |

Spinel blank
Spinel join

The present method therefore enabled the manufacture of high quality samples of fused and joined spinel with good mechanical properties. In addition, very good IR transmission was maintained in the samples post-joining. Advantageously, the present method enables the manufacture of such joined spinel whereas known methods of joining/fusing, such as diffusion melt flow, microwave heating, and ultrasonic joining, produce unsuccessful results.

### Example 6

The present example demonstrates a method of treating a SiAlON component with a composition at a treatment surface to form a treated SiAlON component. The method of treatment may be referred to a nanoslurry infiltration method.

To form the composition, approximately 70 wt % SiAlON nanoparticles having a diameter of between approximately 13 nm and approximately 21 nm were mixed with 0.7 wt % Triton X-100® (octyl phenol ethoxylate) dispersant and approximately 29.3 wt % isopropyl alcohol (IPA) solvent to form a slurry. The SiAlON nanoparticles included a unique mixture of nanoparticle sizes as they included a Si/Al oxide nitride mix.

The slurry was lapped onto the SiAlON component at the treatment surface at approximately 0.5 ml per cm² of the treatment surface. The SiAlON component itself was cylindrical in shape with a diameter of 62 mm. No preparation or scoring was required at the treatment surface. The consistency of the slurry once lapped was similar to that of battery electrode ink.

The SiAlON component was then heated to a treatment temperature for a treatment time period. The experimental parameters for the treatment temperature and the treatment time period are analogous to those provided for the joining SiAlON example in Example 1.

At the treatment surface, pores of the SiAlON component contained infiltrated SiAlON nanoparticles such that the treatment surface was densified. The initial porosity percentage, which was measured using a pycnometer, was 91.5%, whereas after treatment the porosity percentage was 97.0%. The present example therefore demonstrates successful densification of a SiAlON component by way of the treatment method of the presently disclosed subject matter, which leads to greater density and hardness.

Many modifications may be made to the specific embodiments described above without departing from the scope of the invention as defined in the accompanying claims. Features of one embodiment may also be used in other embodiments, either as an addition to such embodiment or as a replacement thereof.

1. A composition for joining and/or treating ceramic materials, the composition comprising:
approximately 15 wt % to approximately 90 wt % ceramic nanoparticles;
approximately 0.1 wt % to approximately 8 wt % dispersant; and
approximately 2 wt % to approximately 84.9 wt % solvent.

2. A composition according to claim 1, wherein the composition comprises approximately 0.5 wt % to 1 wt % dispersant.

3. (canceled)

4. (canceled)

5. A composition according to claim 1, wherein the ceramic material is selected from the group consisting of SiAlON, zinc sulphide (ZnS) and spinel.

6. A composition according to claim 1, wherein the composition comprises approximately 60 wt % to approximately 80 wt % ceramic nanoparticles.

7. A composition according to claim 1, wherein the composition comprises approximately 70 wt % ceramic nanoparticles.

8. A composition according to claim 1, wherein the ceramic material comprises SiAlON and the ceramic nanoparticles have a diameter of approximately 3 nm to approximately 50 nm.

9. A composition according to claim 1, wherein the ceramic material comprises SiAlON and the ceramic nanoparticles have a diameter of approximately 13 nm to approximately 21 nm.

10. A composition according to claim 1, wherein the ceramic material comprises ZnS and the ceramic nanoparticles have a diameter of approximately 15 nm to approximately 50 nm.

11. A composition according to claim 1, wherein the ceramic material comprises spinel and the ceramic nanoparticles have a diameter of approximately 15 nm to approximately 50 nm.

12. A method of joining a first ceramic part and a second ceramic part at a joining interface to form a joined ceramic component, the method comprising:
applying a composition according to claim 1 to the first ceramic part at the joining interface;
arranging the second ceramic part in contact with the composition at the joining interface;
heating the first ceramic part, the second ceramic part and the composition to a joining temperature for a joining time period.

13. (canceled)

14. A method according to claim 12, wherein the composition is applied at approximately 0.5 ml per cm² of the joining interface.

15. (canceled)

16. A method according to claim 12, wherein the joining temperature is approximately 800° C. to approximately 1400° C.

17. A method according to claim 12, wherein the first ceramic part and the second ceramic part comprise SiAlON and the joining temperature is approximately 1000° C. to approximately 1300° C.

18. A method according to claim 12, wherein the first ceramic part and the second ceramic part comprise SiAlON and the joining time period is approximately 120 minutes to approximately 420 minutes.

19. A method according to claim 12, wherein the first ceramic part and the second ceramic part comprise ZnS and the joining temperature is approximately 800° C. to approximately 1185° C.

20. A method according to claim 12, wherein the first ceramic part and the second ceramic part comprise ZnS and the joining time period is approximately 60 minutes to approximately 240 minutes.

21. A method according to claim 12, wherein the first ceramic part and the second ceramic part comprise spinel and the joining temperature is approximately 900° C. to approximately 1125° C.

22. A method according to claim 12, wherein the first ceramic part and the second ceramic part comprise spinel and the joining time period is approximately 60 minutes to approximately 480 minutes.

23. A method of treating a ceramic component at a treatment surface to form a treated ceramic component, the method comprising:
applying a composition according to claim 1 to the ceramic component at the treatment surface;
heating the ceramic component and the composition to a treatment temperature for a treatment time period;
wherein pores at the treatment surface of the ceramic component contain infiltrated ceramic nanoparticles such that the treatment surface is densified.

24. (canceled)

25. A joined ceramic component comprising:
a first ceramic part joined to a second ceramic part; and
a joining region between the first ceramic part and the second ceramic part;
wherein at the joining region surface pores of the first ceramic part and the second ceramic part contain infiltrated ceramic nanoparticles.
